(19) United States
(12) Patent Application Publication
(10) Pub. No.: US 2017/0162975 A1
(43) Pub. Date: Jun. 8, 2017

(54) ELECTRICAL CONNECTOR

(71) Applicant: ADVANCED-CONNECTEK INC., New Taipei City (TW)

(72) Inventors: Yu-Lun TSAI, New Taipei City (TW); Pin-Yuan HOU, New Taipei City (TW); Long-Fei CHEN, New Taipei City (TW); Dong XIANG, New Taipei City (TW); Chung-Fu LIAO, New Taipei City (TW)

(73) Assignee: ADVANCED-CONNECTEK INC., New Taipei City (TW)

(21) Appl. No.: 15/368,215

(22) Filed: Dec. 2, 2016

(30) Foreign Application Priority Data
Dec. 3, 2015 (CN) 201520990637.X

(51) Int. Cl. H01R 13/52; H01R 24/60; H01R 13/6585

(52) U.S. Cl. CPC H01R 13/5202; H01R 13/6585; H01R 24/60; H01R 2107/00

(57) ABSTRACT

An electrical connector is provided, which includes: a first housing having a discontinuous portion, an insulating main body received in the first housing, a shielding piece disposed in the insulating main body, two conductive terminal sets disposed on the insulating main body, a capping body covering the discontinuous portion, and a sealing body coupled with the first housing. By the design of the capping body, water vapor or moisture cannot seep through the discontinuous portion to enter the first housing.

### CROSS-REFERENCE TO RELATED APPLICATION(S)

This application claims priority to Chinese Patent Application No. 201520990637.X, filed on Dec. 3, 2015, the entirety of which is incorporated by reference herein.

### BACKGROUND OF THE INVENTION

1. Field of the Invention

The present disclosure relates to connectors, and more particularly, to electrical connectors.

2. Description of Related Art

With the rapid development of electronics industry, modern electronic products nowadays must include practical and diverse designs. Electrical connectors are connecting devices configured to electrically connect to cables, circuit boards, and other electronic components, and are widely applicable to a variety of electronic products, such as computers, laptop computers, mobile phones, etc.

Conventional the electrical connectors usually have slits or holes disposed on their inner case, however, the design cannot prevent the moisture or water from seeping through the case and further into the electrical connectors, thus ultimately affecting the electrical function. Accordingly, waterproof casings have been designed and provided in the market that can be attached to external electrical connectors for waterproofing, such as the disclosure in Taiwan Patent No. M496259.

However, the electrical connector covered with a waterproof casing occupies a greater space since the waterproof casing is bulky and designed to cover the electrical connector. Therefore, it undesirably increases the size of the electrical connector and cannot satisfy the market demand for miniaturization which may have an impact on the internal layout space for electrical connecters.

As such, how to avoid the problems mentioned above has become an urgent issue that needs to be addressed.

### SUMMARY OF THE INVENTION

In view of the above-described drawbacks, the present disclosure provides an electrical connector, which includes: a first housing having a receiving space, a port and an opening opposite to each other and communicating the receiving space, and at least a discontinuous portion formed on the surface of the first housing and communicating the receiving space; an insulating main body received in the receiving space of the first housing; a shielding piece disposed in the insulating main body; two conductive terminal sets each having a plurality of conductive terminals arranged in a row and parallelly positioned at two opposite sides of the shielding piece, wherein each of the plurality of conductive terminals has a contacting portion exposed from the port, and a welding portion protruding from the opening; at least a capping body attached to the first housing for covering the discontinuous portion thereof; and a sealing body coupled with the first housing and disposed around the port of the first housing.

In the above electrical connector, the discontinuous portion may be a cavity, a slit or a combination thereof. For example, the first housing is formed by bending a metal sheet to allow dovetail grooves on the two ends of the metal sheet to be coupled together, and the slit is formed at the engaged portions of the dovetail grooves. Or, the first housing has a protruding portion formed from its surface and protruding toward the receiving space to engage the insulating main body, and the cavity is defined by the protruding portion and the insulating main body.

In the above electrical connector, the insulating main body includes a base and a tongue blade extending from the base, where the base is located in the opening, and the tongue blade is disposed within the first housing and located in the port.

In the above electrical connector, the capping body is a plastic sheet or a plastic film.

In the above electrical connector, a second housing is disposed on and in contact with the surface of the first housing. For example, the second housing totally or partially covers the surface the first housing. The first housing further has a placement portion sticking out of the second housing and configured to combine with the sealing body.

In the above electrical connector, the sealing body leans against an external device configured to be combined with the electrical connector.

Based on the above, by the design of the capping body covering the discontinuous portion, the electrical connector of the present disclosure is capable of preventing water vapor or moisture from entering the first housing and seeping through the discontinuous portion, thereby protecting electrical functions of the conductive terminals from being damaged by the water vapor or moisture.

In addition, as the capping body is located inside the second housing, there is no need to install any waterproof structure on the external of the second housing, thereby avoiding the increase in size of the electrical connector, such that the electrical connector is not only water proof, but also remains slim, thin and light-weighted.

### BRIEF DESCRIPTION OF DRAWINGS

FIG. 1A is a schematic view of the electrical connector according to the present disclosure;

FIG. 1B is a schematic side view of the electrical connector of FIG 1A when in use;

FIG. 2A is a schematic view of the electrical connector of FIG. 1A without a sealing body;

FIG. 2B is a schematic view showing from under of the electrical connector of FIG. 2A;

FIG. 2A′ is a partially exploded view of the electrical connector of FIG. 2A; FIG. 2B′ is a partially exploded view showing from under of the electrical connector of FIG. 2A′;

FIG. 3A is a schematic view of the electrical connector of FIG. 2A without a second housing;

FIG. 3B is a schematic view showing from under of the electrical connector of FIG. 3A;

FIG. 4A is a schematic view of the electrical connector of FIG. 3A without a first housing and a capping body; and

FIG. 4B is an exploded view of the electrical connector of FIG. 4A.

### DETAILED DESCRIPTION OF PREFERRED EMBODIMENTS

The following illustrative embodiments are provided to illustrate the present disclosure, these and other advantages and effects can be apparent to those skilled in the art after reading this specification.

It should be noted that structures, scales, sizes, etc., shown in all the drawings in reference with the specification, are not intended to limit the present disclosure, but merely facilitate the understanding and reading for those skilled in the art. Modifications and variations in different scale or sizes can be made without departing from the spirit of the present disclosure. Further, the terms such as “upper”, “lower”, “front”, “back”, “left”, “right”, “first”, “second”, “on”, “a” etc. are merely for illustrative purposes and should not be construed to limit the scope of the present disclosure, and any amendment or adjustment of relative relations without substantively changing the technical content is rendered to be in the scope of the present disclosure.

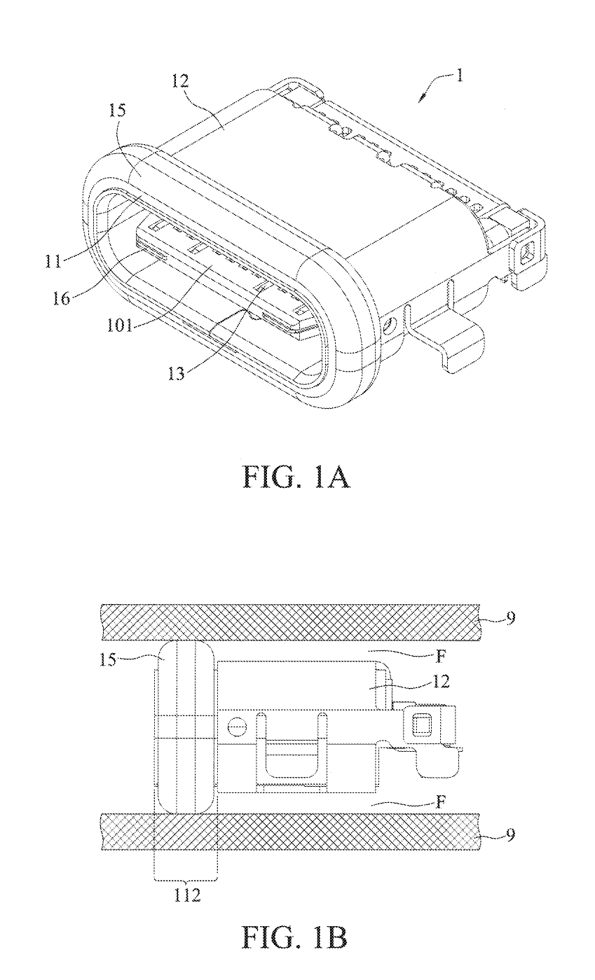

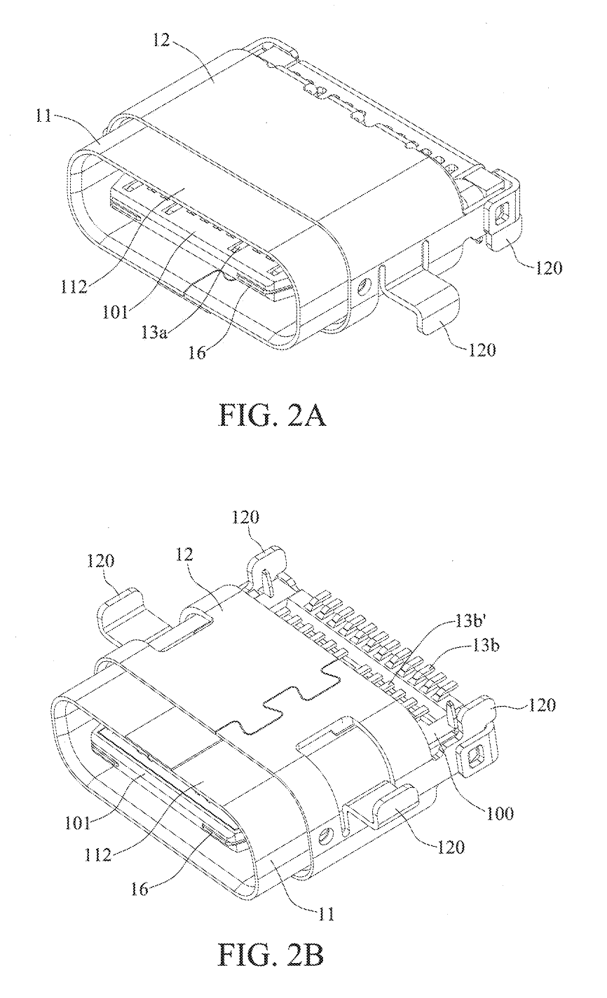

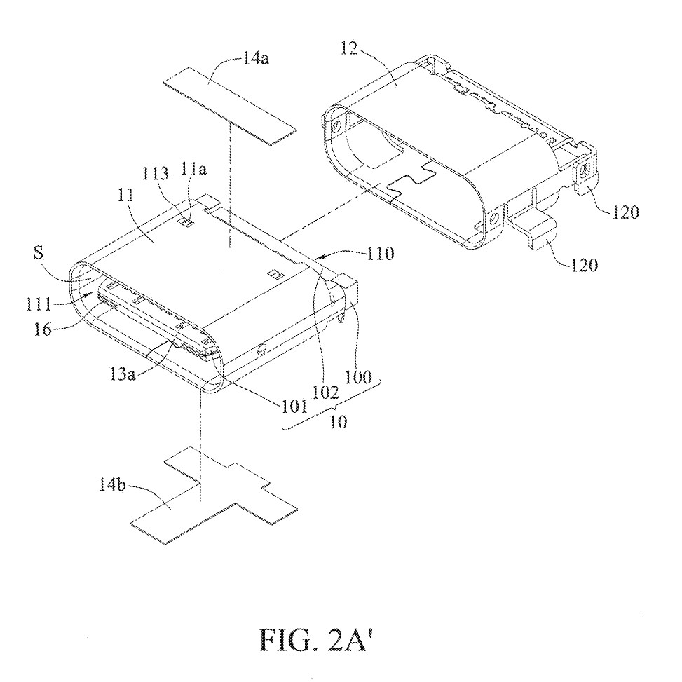

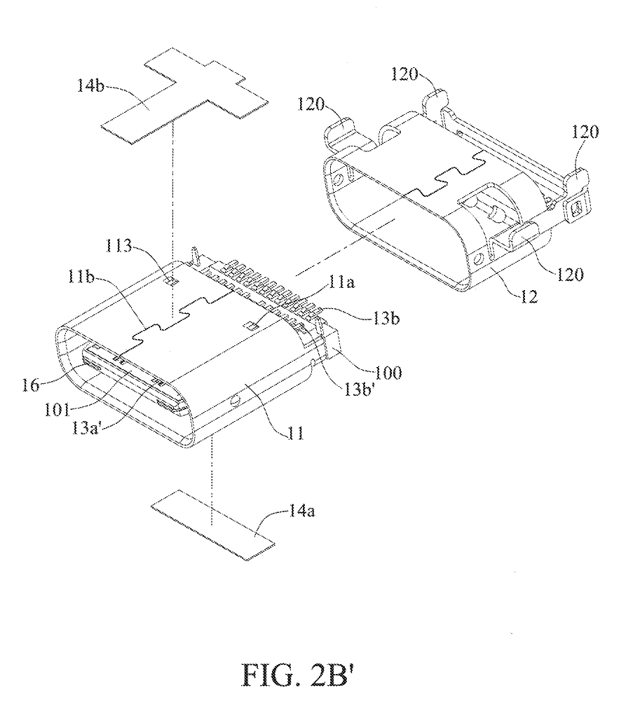

FIGS. 1A, 2A, 2A′, 3A, 4A and 4B are schematic views of the electrical connectors according to the present disclosure; FIGS. 2B, 2B′ and 3B are schematic views showing from under of the electrical connectors according to the present disclosure.

An electrical connector 1 includes an insulating main body 10, a first housing 11, a second housing 12, a shielding piece 16, two rows of conductive terminal sets 13, 13′, a plurality of capping bodies 14a, 14b and a sealing body 15.

In an embodiment, the electrical connector 1 is, for example, a Universal Serial Bus (USB), in particular a USB Type-C configuration.

The insulating main body 10 includes a base 100, a tongue blade 101 and a board portion 102, where the tongue blade 101 extends from the base 100, and the base 100 and the board portion 102 protrude from the rear side of the first housing 11.

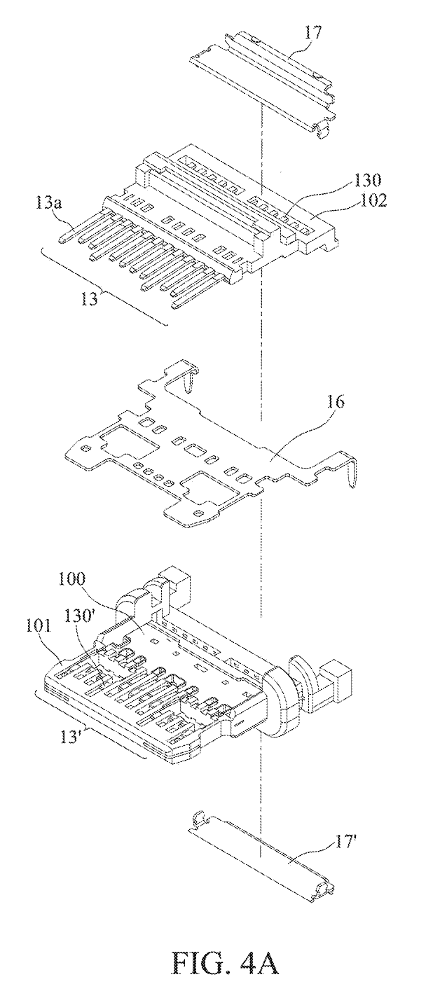

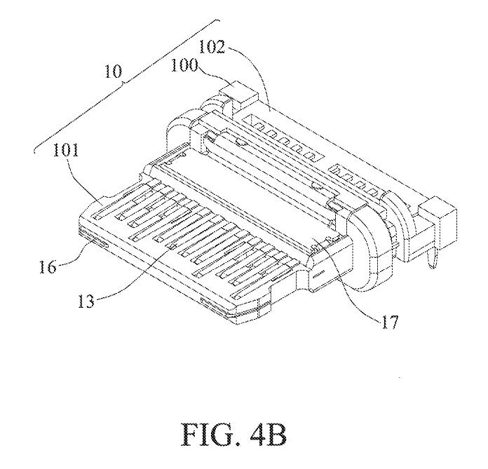

As shown in FIGS. 4A and 4B, the shielding piece 16 is disposed in the insulating main body 10.

The conductive terminal sets 13 and 13′ include a plurality of conductive terminals 130 and 130′ (as shown in FIG. 4A), respectively. The conductive terminal sets 13 and 13′ are firmly disposed on the upper and lower sides of the insulating main body 10, and the conductive terminals 130 and 130′ have contacting portions 13a and 13a′ disposed on the tongue blade 101, respectively, and further have welding portions 13b and 13b′ protruding from the rear side of the first housing, where the welding portions 13b and 13b′ are configured to electrically connect to electronic devices (not shown).

In the embodiment, the conductive terminals 130 and 130′ extend from the tongue blade 101 toward the base 100, and bend and further extend downwardly to present like bending beams.

Moreover, the conductive terminals 130 and 130′ include ground terminals (Gnd), power source terminals (Power/VBUS) and reserve terminals (RFU), and further include differential signal terminal pairs when needed.

Furthermore, the upper conductive terminal set 13 is formed on the board portion 102, where the contacting portions 13a are located on the tongue blade 101 (shown in FIG. 4A), the lower conductive terminal set 13′ extends on the base 100 and the tongue blade 101 and has ground pieces 17 and 17′ disposed on the base 100 and the board portion 102, respectively.

In addition, the conductive terminal sets 13 and 13′ are arranged as rows and disposed on the upper and lowers sides of the shielding piece 16, i.e., the shielding piece 16 is disposed between the upper conductive terminal set 13 and the lower conductive terminal set 13′.

In view of the conventional designs of USB conductive terminals that are well known to persons skilled in the art, further descriptions thereof are not to be elaborated for concise and brevity.

The first housing 11 is a metal housing, such as an iron shell to be used as the inner case and have a receiving space S for receiving the insulating main body 10 and the conductive terminal sets 13 and 13′.

In the embodiment, the first housing 11 further includes at least a discontinuous portion 11a, 11b formed on the surface of the first housing 11 and communicating the receiving space S.

In the embodiment, when forming the first housing 11, a metal sheet is designed to have dovetail grooves on its two ends, then the metal sheet is bended to allow the dovetail grooves to be coupled together, forming an annular shell having a slit (as the discontinuous portion 11b shown in FIG. 2B′) located at engaged portions of the dovetail grooves. Protruding portions 113 (shown in FIGS. 2A′ and 2B′ where two protruding portions 113 on the upper surface of the first housing 11, and four protruding portions 113 on the lower surface of the first housing 11) are formed on the upper and lower surfaces of the first housing 11 by pressing or stamping the same, and protrude toward the receiving space S, i.e., the protruding portions 113 are also located in the receiving space S, such that the protruding portions 113 engage the insulating main body 10. Cavities such as the discontinuous portions 11a shown in FIGS. 2A′ and 2B′ are formed on the front and rear sides of the protruding portions 113.

Accordingly, moisture or water vapor seeps through the slits or cavities that are defined as the discontinuous portions 11a and 11b on the first housing. It should be noted that the variety of the discontinuous portions are not limited to the above configurations.

The first housing 11 further has a port 111 formed on the front side of the receiving space S and an opening 110 formed on the rear side of the receiving space S, where the base 100 is located in the opening 110, the tongue blade 101 is disposed on the first housing 11 and located in the port 111, such that the tongue blade 101 and the contacting portions 13a and 13a′ are exposed from the port 111, and the base 110, the board portion 102, and the welding portions 13b and 13b′ protrude from the opening 110.

The second housing 12 is a metal casing, such as an iron shell to be used as an external case disposed on and in contact with the surface of the first housing 11, so as to cover the first housing 11 and conceal the rear upper side of the base 100, such that the first housing 11 protrudes from the front side of the second housing 12 to form a placement portion 112, as shown in FIG. 2A, i.e., the first housing 11 has the placement portion 112 sticking out of the second housing 12.

In the embodiment, as shown in FIG. 2B, the base 100 and the welding portions 13b and 13b′ are exposed from the rear lower side of the second housing 12.

In addition, the second housing 12 further has a plurality of pins 120 on the left side and right side of the second housing 12, and the pins 120 are close to the front side and rear side of the second housing 12, allowing the electrical connector 1 to be assembled to an electronic device (not shown).

And, the second housing 12 partially covers the surface of the first housing 11. Nevertheless, it should be understood that the second housing 12 can also totally cover the surface of the first housing 11.

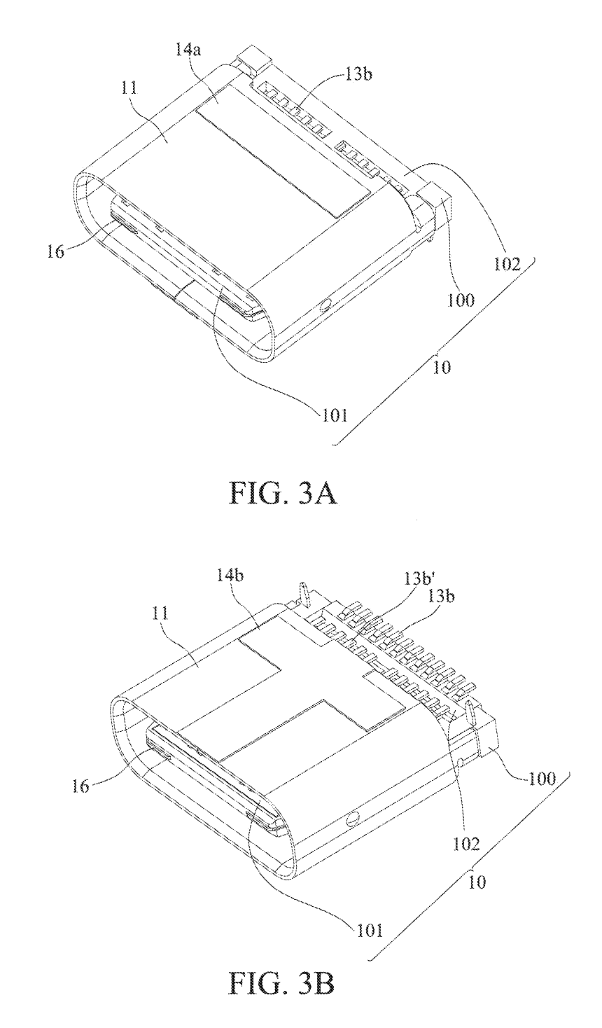

The capping bodies 14a and 14b are disposed on and in contact with the upper and lower sides of the first housing 11 for covering entirely the discontinuous portions 11a and 11b (shown in FIGS. 3A and 3B), and the capping bodies 14a and 14b are received in the second housing 12, such that the second housing 12 covers the capping bodies 14a and 14b (shown in FIGS. 2A and 2B).

In the embodiment, the capping bodies 14a and 14b are sheets or films formed in the shape corresponding to the distribution layout of the discontinuous portions 11a and 11b, such as shaped as a bar, a cross or the like.

In particular, the capping bodies 14a and 14b are formed by a plastic material, such as Mylar products produced by E. I. du Pont de Nemours and Company.

The sealing body 15 is combined with the placement portion 112 of the first housing 11, and is exposed from the second housing 12.

In the embodiment, the sealing body 12 is an annular-shaped insulating pad or an elastic ring (so called O-ring), or the like.

Also, as shown in FIG. 1B, the height of the sealing body 15 relative to the first housing 11 is greater than the height of the second housing 12 relative to the first housing 11.

Therefore, by covering the capping bodies 14a and 14b over the discontinuous portions 11a and 11b, the electrical connector 1 of the embodiment is capable of preventing water vapor or moisture from entering the first housing 11 and seeping through the discontinuous portions 11a and 11b, thereby protecting electrical functions of the conductive terminals 13 and 13′ from water vapor or moisture.

Moreover, since the capping bodies 14a and 14b are located inside the second housing 12, there is no need to install any waterproof structure on the external of the second housing 12, avoiding the increase in size of the electrical connector 1, such that the electrical connector 1 remains thin and light-weighted.

Further, when the electrical connector 1 is combined with an external device 9 to form a product (not shown), the sealing body 15 leans against the external device 9, which prevents moisture from passing through the flowing space F between the external device 9 and the second housing 12, thereby preventing moisture from entering the product through the flowing space F and effectively achieving waterproofing of the device. Therefore, the electrical connector 1 of the present disclosure is equipped with the waterproofing feature by merely forming the sealing body 15 on the first housing 11, which avoids the conventional bulky waterproof casing that covers the second housing 12. Although the outer profile around the port 111 of the electronic connect 1 is slightly enlarged, the internal layout space of the product is not affected, thereby satisfying the market demand for slim, thin and light-weighted products.

In conclusion, by the use of the capping bodies over the discontinuous portions of the first housing, the electrical connector of the present disclosure not only prevents water vapor or moisture from seeping through the discontinuous portions of the first housing, but also the electrical connector is slim, thin and light-weighted.

The above-described descriptions of the detailed embodiments are only to illustrate the preferred implementation according to the present disclosure, and it is not to limit the scope of the present disclosure. Accordingly, all modifications and variations completed by those with ordinary skill in the art should fall within the scope of present disclosure defined by the appended claims.

What is claimed is:

1. An electrical connector, comprising:
a first housing having a receiving space, a port and an opening opposite to each other and communicating the receiving space, and at least a discontinuous portion formed on a surface of the first housing and communicating the receiving space;
an insulating main body received in the receiving space of the first housing;
a shielding piece disposed in the insulating main body;
two conductive terminal sets each comprising a plurality of conductive terminals arranged in a row coupled to the insulating main body and parallelly positioned at two opposite sides of the shielding piece, wherein each of the plurality of conductive terminals has a contacting portion exposed from the port, and a welding portion protruded from the opening;
at least a capping body attached to the first housing for covering the discontinuous portion thereof; and
a sealing body coupled with the first housing and disposed around the port of the first housing.

2. The electrical connector of claim 1, wherein the discontinuous portion is a cavity, a slit, or a combination thereof.

3. The electrical connector of claim 2, wherein the first housing is formed by bending a metal sheet to allow dovetail grooves on two ends of the metal sheet to be coupled together, and the slit is formed at the engaged portions of the dovetail grooves.

4. The electrical connector of claim 2, wherein the first housing further has a protruding portion formed from the surface of the first housing and protruding toward the receiving space, the protruding portion is configured to engage the insulating main body, and the cavity is defined by the protruding portion and the insulating main body.

5. The electrical connector of claim 1, wherein the insulating main body comprises a base and a tongue blade extending from the base, the base is located at the opening, and the tongue blade is disposed in the first housing and located at the port.

6. The electrical connector of claim 1, wherein the capping body is a plastic sheet or a plastic film.

7. The electrical connector of claim 1, wherein a second housing is disposed on the surface of the first housing and in contact with the first housing.

8. The electrical connector of claim 7, wherein the second housing covers entirely the whole surface of the first housing or covers partially the surface of the first housing.

9. The electrical connector of claim 7, wherein the first housing has a placement portion protruding out of the second housing and configured to combine with the sealing body.

10. The electrical connector of claim 9, wherein the sealing body leans against an external device configured to be combined with the electrical connector.

11. The electrical connector of claim 1, wherein the sealing body leans against an external device configured to be combined with the electrical connector.
